(19) United States
(12) Patent Application Publication
(10) Pub. No.: US 2007/0226150 A1
(43) Pub. Date: Sep. 27, 2007

(54) Distribution of digital licenses and software via license tokens

(76) Inventors: Brent Pietrzak, Lafayette, CA (US); Tobid Pieper, Orinda, CA (US); Ariane Habets-Heil, Pleasant Hill, CA (US); Donald Turtle, Orinda, CA (US); Paul Martinelli, Berkeley, CA (US)

Correspondence Address: GLENN PATENT GROUP, 3475 EDISON WAY, SUITE L, MENLO PARK, CA, 94025, US

(21) Appl. No.: 11/391,665

(22) Filed: Mar. 27, 2006

(51) Int. Cl. G06Q 99/00

(52) U.S. Cl. 705/59

(57) ABSTRACT

A method and apparatus for distribution of digital licenses and software via license tokens allows an end user access to software licenses or products by providing a licensing token, allowing a unique code or token to substitute for authentication. A distributor distributes software and licenses for software manufacturers. The software manufacturer supplies the service with the relevant information that defines the license token indicating which licenses and which products the token entitles a user to access. The distributor processes this token definition and makes the relevant product and license available when the user supplies the license token. A method of anonymous token-based licensing allows the end user to obtain a product license file without providing any information other than the token. A method of registered token-based licensing requires that the end user create a user profile, in addition to providing the token.

### BACKGROUND OF THE INVENTION

1. Field of the Invention

The invention relates generally to digital rights protection. More particularly, the invention relates to digital rights management using license tokens.

2. Discussion of Related Art

The processes for distributing software and for distributing the licenses that unlock it are closely related. Both are based on the same entitlement data, both are received by the same end users, and both are needed for installation and operation of the product. Previously, to distribute software or software licenses electronically, it was necessary for a user to supply information such as a name, physical location, and email address—a process commonly known as user registration.

User registration is an important tool for providing usage protection of distributed digital goods. The user registration process greatly decreases the possibility that a digital item such as a computer program will fall into the hands of someone who has no right to possess or use the item. The software supplier uses the process to control access to the product and to track those having access to the product. User registration can, however, hamper distribution of software and licenses. It is a complicated process to implement and maintain, requiring the creation and maintenance of an account for each user. The registration process must be carefully designed, coded and implemented. Executing the process for each of a multitude of users consumes significant computing resources and the user data must be stored and safeguarded against theft and corruption. Additionally, users may avoid registering for a variety of reasons. They simply may not want to bother with the registration process or they may be hesitant to provide the requested information because of security and confidentiality concerns. Thus, finding a way to control usage that dispensed with the user registration process would greatly enhance the ease and efficiency of electronic software distribution.

Anonymous FTP (file transfer protocol) is a network protocol that allows a user to access a remote FTP server without needing an account on that machine, completely eliminating a user registration process. Generally, the user merely needs to supply the username “anonymous.” Although the user is prompted for a password, it is generally unnecessary to provide one. After logging on to a remote system using an FTP client, the anonymous user is free to negotiate the directory structure on the remote system and transfer binary files, images, text files and other information to the user's own computer. However, access to an anonymous FTP server and the contents housed thereon is virtually unfettered. While such open access is well suited to certain distribution schemes where the interest in controlling usage is low, such as for materials in the public domain, it provides no effective way to limit usage to a certain group of users, for example, purchasers of a software product.

One system provides a token-based authentication system designed to allow secure data retrieval. The token-based authentication system embeds the token in a download request for information itself. In this way, the download or content server authenticates the download request using the token contained in the download request information and therefore does not directly require access to user account information to carry out the authentication. However, although the system provides for token-based authentication, wherein provision of the token substitutes for authentication, the user must have an existing account on the system. In this way, the system does not provide completely anonymous access to the content.

### SUMMARY OF THE INVENTION

A method and apparatus for distribution of digital licenses and software via license tokens allows an end user access to software licenses or products by providing a licensing token, thus allowing a unique code or token to substitute for user registration and authentication.

In a preferred embodiment, a distributor distributes software and licenses for software manufacturers. The software manufacturer supplies the service with the relevant information that defines the entitlement associated with the token indicating which licenses and which products the token entitles a customer to access. The distributor processes this token definition and makes the relevant product and license available when the user supplies the license token.

One embodiment of the invention provides a method of anonymous token-based licensing that allows the end user to obtain a product license file without providing any information other than the token. A further embodiment of the invention provides a method of registered token-based licensing. Registered token-based licensing requires that the end user create a user profile, in addition to providing the token.

License key distribution via token provides a number of important advantages to the software producer. Among these are:
Elimination of the manual processes typically associated with license key distribution;
It may allow the software producer to utilize sophisticated licensing strategies within a product, such as node-locked licensing, because it allows user input to be obtained;
In the case of channel distribution, it may provide the software producer to collect end user information that would otherwise be hidden to the producer by the channel; and
It may provide the software producer an opportunity to capture product installation data.

### BRIEF DESCRIPTION OF THE DRAWINGS

FIG. 1 illustrates exemplary network architecture for digital license and software distribution via license tokens according to the invention;

FIG. 2 provides a block diagram of a database for storing and managing license tokens and entitlements according to the invention;

FIG. 3 provides a screenshot of a user interface for submitting a license token according to the invention;

FIG. 4 provides a top-level flow diagram of a method for digital license and software distribution via license token according to the invention;

FIG. 5 provides a flow diagram of a process for registering a license token according to the invention;

FIG. 6 provides screenshot of a user interface for creating a customer profile according to the invention;

FIG. 7 provides a screenshot of a user interface for viewing tokens registered to a customer account according to the invention;

FIG. 8 provides a flow diagram of a process for displaying a license overview to a customer according to the invention;

FIG. 9 provides a flow diagram of a process for viewing and generating a license associated with an anonymously registered license token according to the invention;

FIG. 10 provides a screenshot of a user interface for viewing and generating a license associated with an anonymously registered license token according to the invention;

FIG. 11 provides a flow diagram of a process for viewing and generating a license associated with a profile-registered license token and downloading licensed software according to the invention;

FIG. 12 provides a screenshot of a user interface for viewing and generating a license associated with a profile-registered license token according to the invention;

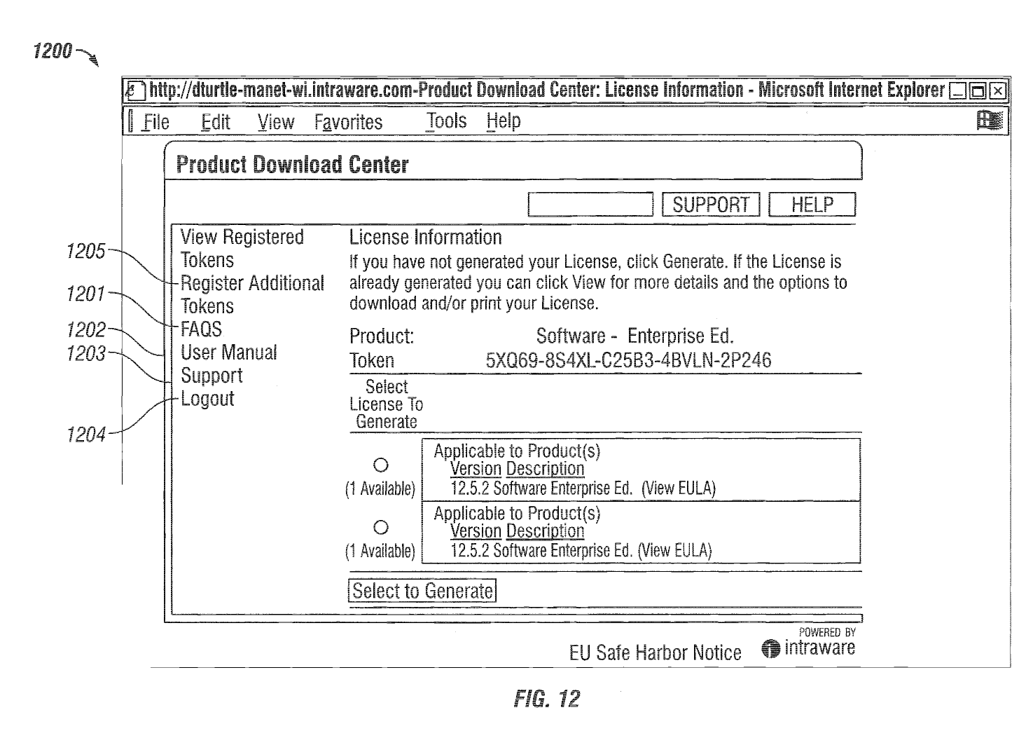

FIG. 13 provides a flow diagram of a process for registering additional license tokens to a customer account according to the invention;

FIG. 14 provides a screenshot of a user interface for registering additional license tokens to a customer account according to the invention; and

FIG. 15 is a diagrammatic representation of a machine in the exemplary form of a computer system within which a set of instructions may be executed.

### DETAILED DESCRIPTION OF THE INVENTION

The invention involves a system and method for providing goods and services in exchange for a redeemable token that incorporates a security authentication feature. At a base level, redemption of the token may be anonymous. At a higher level, redemption may require registration of the token bearer. While the exemplary embodiment of the invention applies primarily to software assets and licenses, the invention is applicable to virtually any type of merchandise or service that can be sold electronically.

One embodiment of the invention provides a method and system for distribution of digital licenses and software via license tokens that allow distribution of software licenses and products electronically without requiring user registration. The invention eliminates the need to collect user information, such as name, address, email address and so on, at the time of distribution. Instead, anonymous submission by a software customer of a license token to a software distributor substitutes for registration and subsequent authentication. The license token provides a unique identifying token that the customer can supply to access the appropriate license and/or software product from the software producer. Additionally, the invention greatly simplifies license key distribution by substantially eliminating the manual processes involved in license key distribution.

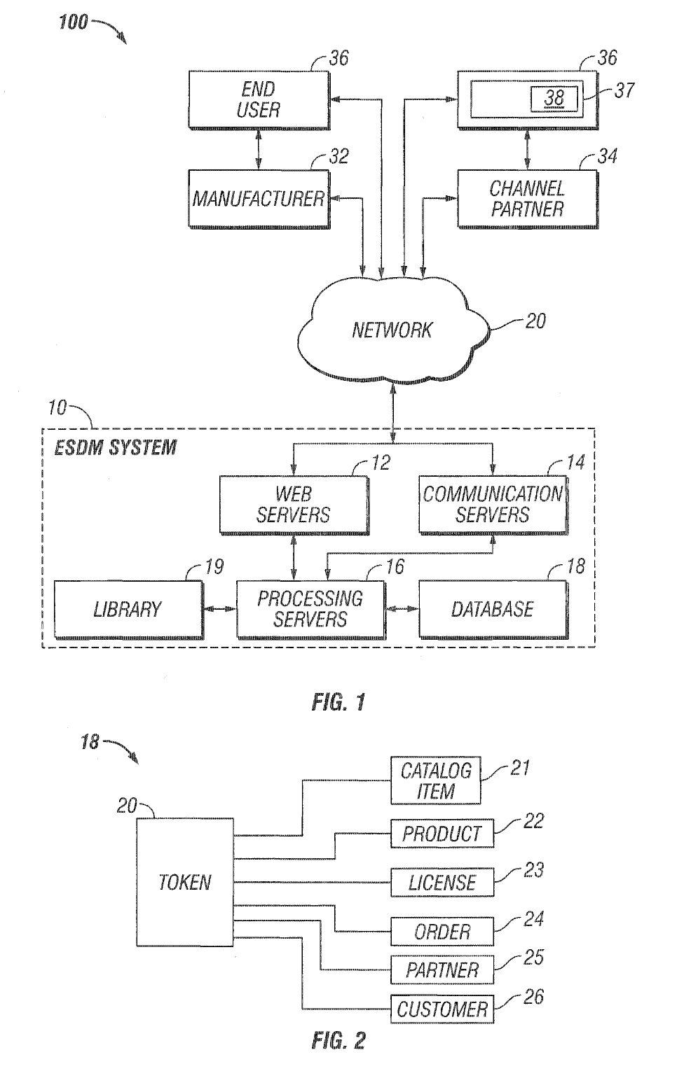

One aspect of the invention concerns an electronic software delivery and management (ESDM) system, which may be embodied by various hardware components and interconnections, with one example being described by the exemplary network environment 100 of FIG. 1. The system 100 includes various subcomponents, each of which may be implemented by one or more hardware devices, software devices, a portion of one or more hardware or software devices, or a combination of the foregoing. The makeup of these subcomponents is described in greater detail below, with reference to an exemplary digital data processing apparatus, logic circuit, and signal-bearing medium.

The environment 100, as illustrated in FIG. 1, includes multiple customers (exemplified by users 36) and an ESDM system 10. The customers 36 may also be referred to as a “client.” The ESDM system 10 may be accessed by a client program 38, such as a browser, e.g. the Internet Explorer browser distributed by Microsoft Corporation of Redmond, Wash., that executes on a client machine 37 residing at the customer's 36 site and accesses the system 10 via a network 20, such as, for example, the Internet. Other examples of networks that a client may use to access the system 10 includes a wide area network (WAN), a local area network (LAN), a wireless network, e.g. a cellular network, the Plain Old Telephone Service (POTS) network, or other known networks. The customer 36 seeks access to digital objects stored in a library 19, having earlier subscribed to (or been entitled by the owner or developer of the digital objects) to ESDM services offered by an ESDM entity that operates the ESDM system 10.

The environment 100 further includes multiple digital object manufacturers, such as, for example, software applications manufacturers (exemplified by manufacturer 32) and multiple channel partners (exemplified by channel partner 34), which also access the system 10 via the network 20. In one embodiment, the channel partner 34 may be a large entity in a predetermined business relationship with the manufacturer 32, such as, for example, a distributor of software applications or an original equipment manufacturer (OEM), which is enabled to access the system 10 and to place and process orders for the associated end users 36. Alternatively, the channel partner 34 may be a small entity in a predetermined business relationship with the manufacturer 32, such as, for example, an application partner of the manufacturer 32. The manufacturers 32 and channel partners 34 access the system 10 via corresponding client machines residing at their respective sites, each client machine having a corresponding browser.

The system 10 further includes one or more of a number of types of front-end web servers 12, such as, for example, web page servers, which deliver web pages to multiple users, picture servers, which deliver images to be displayed within the web pages, and content servers, which dynamically deliver content information to the customers 36, the manufacturers 32 and the channel partners 34. In addition, the system 10 may include communication servers 14 that provide, inter alia, automated electronic mail (email) communications to/from customers 36, manufacturers 32, and channel partners 34, and automated real-time communications, such as, for example, instant messaging (IM) functionality.

The system 10 further includes one or more back-end servers, such as, for example, processing servers 16 or FTP servers, for enabling functionality of the system 10, specifically for facilitating delivery of digital objects, such as, for example, software applications, from software manufacturers 32 and channel partners 34 to their aggregated customer base (end users 36), as described in further detail below, and other known back-end servers configured to enable functionality of the system 10. The processing servers 16 are further coupled to a library 19, which stores the digital objects, and a database 18, which may, in one embodiment, be implemented as a relational database, and which contains data related to the customers 36, the manufacturers 32, and the channel partners 34, as described in further detail below. In an alternative embodiment, the database 18 may be implemented as a collection of objects in an object-oriented database.

In one embodiment, the web servers 12 may be implemented by a variety of known machines, such as computer workstations, personal computers, etc. The web servers 12 also perform specific tasks such as presenting a web page providing instructions for customers seeking access to digital objects in the library, authenticating users according to the web server access codes, generating temporary FTP access codes for authenticated customers' use at the servers 16, and redirecting authenticated customers to the servers 16.

The servers 16 comprise some or all of one or more digital data storage machines, such as a UNIX, Linux, Microsoft NT, Microsoft Windows. The processing servers 16 perform specific tasks such as authenticating customers according to temporary access codes and, upon successful authentication, making digital objects from the library 19 available to the customers pursuant to a predetermined mapping. It should be noted that the various servers 12, 14, and 16, shown in FIG. 1, could physically represent different servers in geographically disparate locations and need not be limited to a single server or a group of servers in a single geographic location. It should also be noted that one or more other servers may exist in the connections between the various parties 32, 34 and 36 and between the parties 32, 34, 36 and the various servers, 12, 14, 16, with it being understood that these other servers are collectively represented within the Internet of other computer network.

The system 100 includes various subcomponents, each of which may be implemented by one or more hardware devices, software devices, a portion of one or more hardware or software devices, or a combination of the foregoing. The makeup of these subcomponents is described in greater detail below, with reference to an exemplary digital data processing apparatus, logic circuit, and signal-bearing medium.

In one embodiment, the ESDM system 10 serves to manage discovery and delivery of digital objects from the library 19 to customers 36 that are authorized to receive such objects by subscription, contract, payment, or other arrangement, such as, for example, customers 36 entitled to product documentation or applications comprised of several data objects. As a particular example, the ESDM system 10 may be implemented using the hardware structure (with various changes according to the present disclosure) used to implement the SubscribeNet® service of Intraware, Inc., of Orinda, Calif., which has been in commercial use for some time.

The library 19 contains many different stored digital objects such as software, data constructs, data files, or other machine-readable digital objects. The library 19 comprises some or all of one or more data storage devices, machines, physical or logical storage constructs, etc, such as, for example, software programs, updates, revisions, and the like. For instance, a third party software producer may contract with the entity operating the ESDM system 10 to provide authorized customers with access to that third party's software applications.

In a presently preferred embodiment of the invention, a software producer produces the tokens and supplies the operator of the ESDM system with a copy of each token, along with the relevant information to define what license(s) and what product(s) the token entitles the user to access.

The ESDM operator stores their copy of the token. Subsequently, the license token is then distributed to the customer, preferably by the software producer or a partner to the software producer. In one embodiment of the invention, the producer distributes tokens via physical shipment, such as, for example, as an attachment to a software distribution box. Other methods of distributing the software token, such as by download from a producer web site or by email attachment are within the scope of the invention.

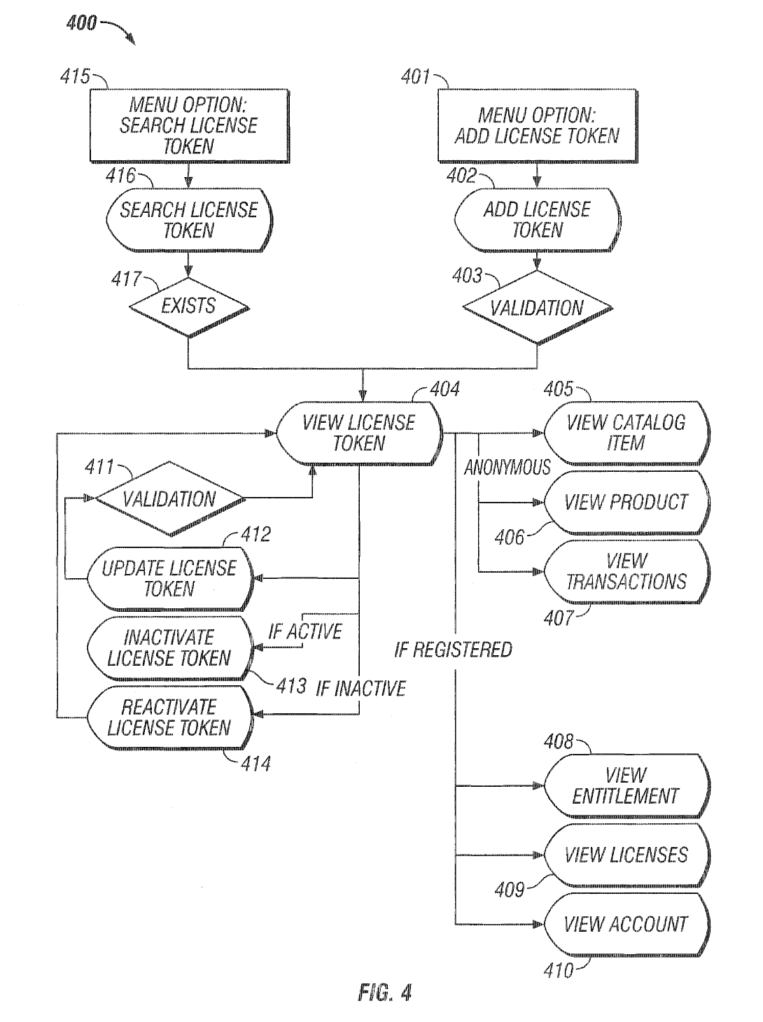

After the customer purchases the software, thus obtaining the license token, he or she is directed to a network location or document, such as a web site, URL, or web page, where the license token can be entered. Upon being presented the token, the ESDM system processes the token definition to make the appropriate product and license available to the token bearer. FIG. 3 illustrates an exemplary user interface for entry of the license token. Such a user interface may include a user interface element such as a text box 301 for accepting an alphanumeric string or code that is manually entered or pasted in by the customer. Additionally, the user interface may include a search function or a pointer that the customer uses to indicate the exact location of the token object on the client computer. Additionally, such user interface includes a user interface element 302 for submitting the entered license token to the ESDM system 100. Upon entry of the license token, the customer receives access to the software and/or license to which the token entitles him or her.

An embodiment of the invention grants the customer access to the software and license merely by the customer submitting the license token anonymously, without the requirement of creating a user profile. Anonymous submission provides the advantage of ease-of-use to customers not wishing to take the time to create a profile. Additionally, a customer may not wish to provide profile information. Anonymous submission allows the customer to obtain the software without providing private information.

A further embodiment gives the customer the option of anonymous registration and profile registration. Creating a user profile entitles the registered customer to services not provided to anonymously registered customers. For example, an array of customer support services can be provided to registered users that it is not possible to provide to those submitting a token anonymously. Furthermore, the registered user can be presented a view of the entire entitlement to the product associated with the token. In addition, a registered user can be given the privilege of registering other members to the account, and he or she can be allowed to set email and product preferences. Registered users can have different statuses, with different privileges associated with each status. For example, one having administrator status can be allowed to set preferences for other users.

In addition to those advantages previously mentioned, creation of a user profile provides particular advantages for the software producer. Among these are:
The software producer, or a partner, is able to utilize more sophisticated licensing within a product, for example, node-locked licensing, than is possible with completely anonymous licensing, because user input can be obtained;
In the case of software distributed by a channel partner, creation of a user profile provides an opportunity for the software producer to collect end user contact information that would otherwise be hidden from the producer because of the channel distribution; and
It provides an opportunity for the software producer to capture product installation data.

In general, a method of distributing software licenses and products via licensing token according to the invention involves steps of:
Generating tokens;
Transmitting tokens;
Storing tokens;
Creating a license based on a token; and
Distributing entitled licenses and/or software to a customer presenting one or more tokens.
   Generating Tokens

In an exemplary embodiment, the software producer generates the licensing token. The licensing token constitutes a token or pass code that, when presented to the ESDM system and compared with the ESDM system's copy of the token, points to all of the information necessary to entitle a customer to a specific product license. In one embodiment, the token may be a pass code: a unique expression, string, or value that authorizes the holder to create an entitlement and obtain one or more licenses. Other forms of token, such as coupons bearing a unique identifier, will occur to the practitioner having an ordinary level of skill. Such alternatives are completely within the scope of the invention. Additionally, while an exemplary embodiment of the invention contemplates that the token will be printed and distributed in hard copy form, it is also possible that the token will be in digital format, a digital certificate for example.

After the tokens are generated by, for example, the software producer, the tokens are distributed to customers of the software producer. The license token is distributed to the customer via, for example, physical shipment. Thus, the license token may take the form of an attachment to a software distribution box. However, other modes of delivery are within the scope of the invention, for example, electronic delivery. Additionally, other parties may generate and/or distribute the tokens. For example, a VAR (value-added reseller) or retail partner may be tasked with either or both of the tasks of generating and distributing the tokens. An embodiment is possible wherein the ESDM operator generates tokens and transmits them to the producers and/or the channel partners for distribution.

In a presently preferred embodiment of the invention, a software producer produces the tokens and supplies the operator of the ESDM system with a copy of each token, along with the relevant information to define what license(s) and what product(s) the token entitles the user to access. Table 1 below provides a plurality of elements with which the producer can define the license:

TABLE 1

| Element | XML Type | DB Type | Description |
|---|---|---|---|
| TokenID | String | String | Unique, hard-to-guess value that will |
| | | | authorize the holder to create an |
| | | | entitlement and obtain license(s) |
| CatalogItemID | String | String | Catalog Item ID, used to create an |
| | | | entitlement |
| ProductID | String | String | Supplier's Product ID. If specified, then |
| | | | the Token is only valid for this particular |
| | | | Product. If not specified, the Token will |
| | | | be valid for all Products under the Catalog |
| | | | Item, within constraints of the Entitlement. |
| LicenseTypeID | String | String | License Type ID, so as to create the |
| | | | proper Entitlement and to find the proper |
| | | | license rules. |
| Quantity | Integer | Integer | The quantity to be used when creating the |
| | | | Entitlement |
| OrderID | String | String | A reference to the order used to provide |
| | | | this Token |
| LineNumber | Integer | Integer | A reference to the order line number used |
| | | | to provide this Token |
| OrderDate | Date | Date | A reference to the supplier order used to |
| | | | provide this Token |
| EffectiveDate | Date | Date | The effective date to be used when |
| | | | creating the entitlement. |
| ExpirationDate | Date | Date | The expiration date to be used when |
| | | | creating the Entitlement |
| PartnerID | String | String | A partner identifier, supplied by supplier |
| Register | Boolean | Char | Indicator to dictate whether the bearer of |
| | | | the token can or must provide registration |
| | | | data. Valid values are Y = Yes, N = No, |
| | | | O = Optional |
| Deliver | Boolean | Char | Indicator to dictate whether to provide |
| | | | ESD access to the Product(s) |
| AdminPrivilege | Boolean | Char | Indicator to dictate whether to create the |
| | | | Member with Admin privileges. |
| GeneratePassword | Boolean | Char | Indicator to dictate whether to ask the |
| | | | customer to enter a password in order to |
| | | | access the license file(s) or other results |
| | | | of entering the token again. |
| ExpirationDate | Date | Date | Date after which the Token will no longer |
| | | | be accepted. |

The above data structure is illustrative and is not intended to limit the invention. In actual fact, other data structures that include only some or even none of the above elements are within the scope of the invention. Furthermore, the labels or names assigned to the data elements are a matter of design choice and, thus, differently named or differently labeled data elements are also within the scope of the invention.

Transmitting Tokens

Transmission of tokens and the licensing definitions is typically accomplished via, for example, an XML-based data feed originating from, for example, the software producer. The data feed specifies which tokens are being entitled to which part numbers, and under what license and maintenance terms. The data feed may also contain other vendor-specific information, such as license keys and support codes. Additionally, tokens and licensing definitions may be delivered by means of a transaction file uploaded to a server, or by means of one or more data files transferred from a producer's client to an FTP server associated with the ESDM. Other methods of transmitting order information to the system may be envisioned by one having an ordinary level of skill and are well within the scope of the invention.

Storing Tokens

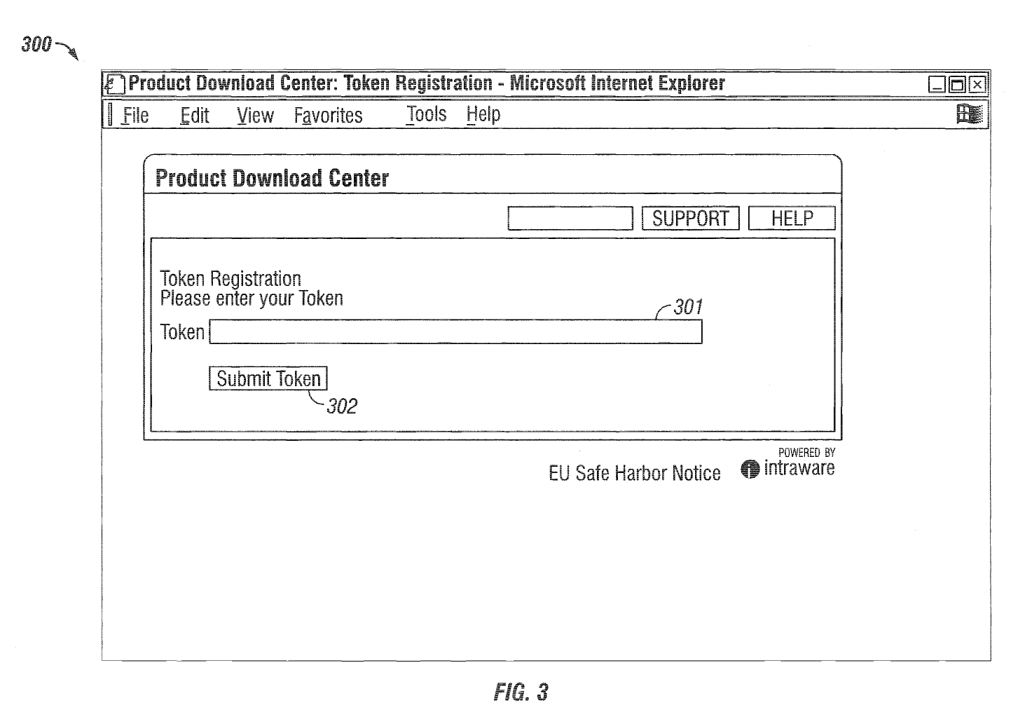

Preferably, tokens and the associated license descriptions are transmitted to the ESDM system before being distributed to customers and end-users. As illustrated in FIG. 2, in one embodiment, the database 18 contains one or more token tables 20, wherein the tokens and metadata relating to the tokens are stored, preferably indexed by token identifier. In one embodiment, the token tables link to one or more producer tables, including for example catalog item tables 21 and product tables 22. In one embodiment, the token tables also link to one or more license tables 23. In one embodiment, that token tables link to one or more order tables 24. In one embodiment, the token tables link to one or more partner tables 25. Additionally, in the case wherein the customer presenting the token has elected to create a customer profile the one or more token profiles may link to one or more customer tables 26.

Upon presentation of a token the token must be validated. An initial step of the validation process involves comparing the submitted copy of a token with the copy stored in the database to determine that it is valid. After a submitted token is validated, the ESDM generates a license according to the license description associated with the license token. In certain embodiments, if the license definition associated with the token permits it, the customer is permitted direct access to the software produce without generating a license.

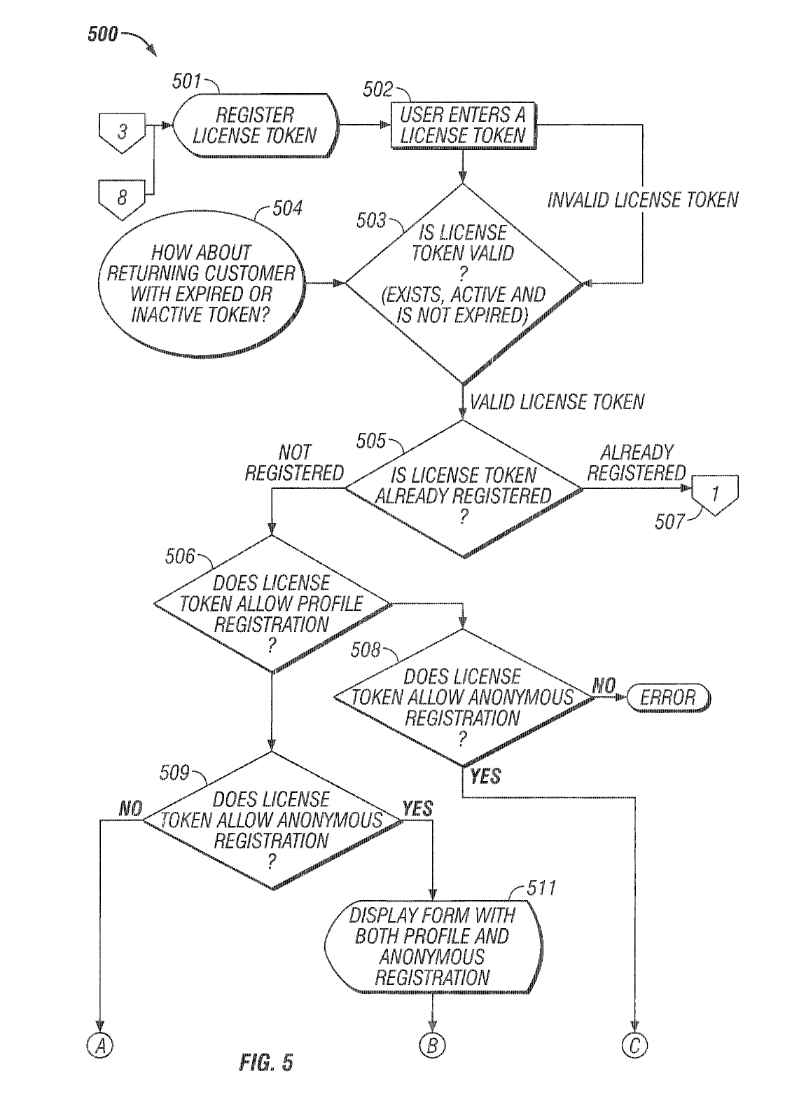

FIG. 4 provides a flow diagram of a method 400 for distribution of digital licenses and software via license tokens according to the invention. As shown, the flow diagram depicts use cases of:
a customer submits a new license token (401), denoted here by the legend “Menu option: Add License Token;” and
a returning customer submits a previously submitted license token to gain further access to the entitled license(s) denoted here by “Menu option: Search License Token;” 415, and/or software.
   Creating a License Based on a Token: a Customer Submets a New License Token

Selection of the appropriate menu option from the user interface launches a user interface element for entering a license token. The customer enters the license token and submits it by activating the necessary user interface element. Thus, the user adds the license token 402. Subsequently, the license token is validated 403. In the case that the token is valid, process flow proceeds to “view license token” 404.

Creating a License Based on a Token: a Returning Customer Submits a Previously Submitted License Token

In the current case, the customer selects the “Search License Token” option. Again, a user interface element for entering a license token launches. The customer submits the license token, whereupon, the system searches for the license token 416. Upon determining that the license token exists on the system 417, process flow proceeds to “view license token” 404. In the case of a previously submitted license token, a number of additional processing steps are possible. First, the customer may update a license token 412. In this case, the license token may have expired, or the entitlement associated with the license token may have changed. For example, a new release of the associated software product may have been issues, or changes have been made that require provision of a new license. In any case where the license token is to be updated, the updated token is validated 411. After validation, process flow proceeds to “view license token” 404.

In the case of a currently active license token, the token may be inactivated 413. In the case of an inactivated token, the token may be reactivated 414. In either case, process flow then proceeds to “view license token” 404.

In either case of a newly submitted or previously submitted token, process flow is substantially identical after “view license token” 404. Process steps 405-407 relate to the use case of an anonymously registered license token. It should be appreciated that the anonymously licensed customer is accorded a lower level of trust than the registered customer, and thus, the access granted the anonymously licensed customer is restricted. The anonymously licensed customer is given access only to the licensed product 406 associated with a licensed catalog item 405. Additionally, the customer may view transactions 407 regarding this particular license product. Thus, the customer may access a record of previous activity related only to this particular license and/or product. While the license and the access is granted within the larger context of an entitlement, the anonymously-registered customer, lacking a user account, is excluded from any greater access than that associated to the particular license token submitted.

In accord with the greater level of trust extended to a registered customer, the registered user is granted access to an entire entitlement 408 and all licenses 409 associated to the entitlement. Additionally, the registered customer is granted access to his or her own account information 410.

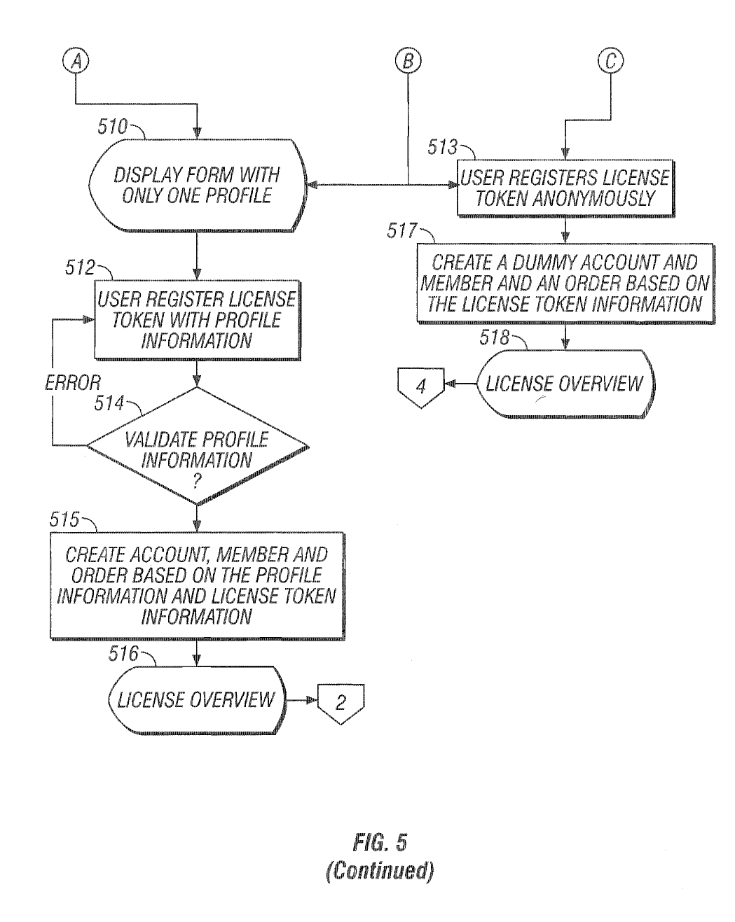

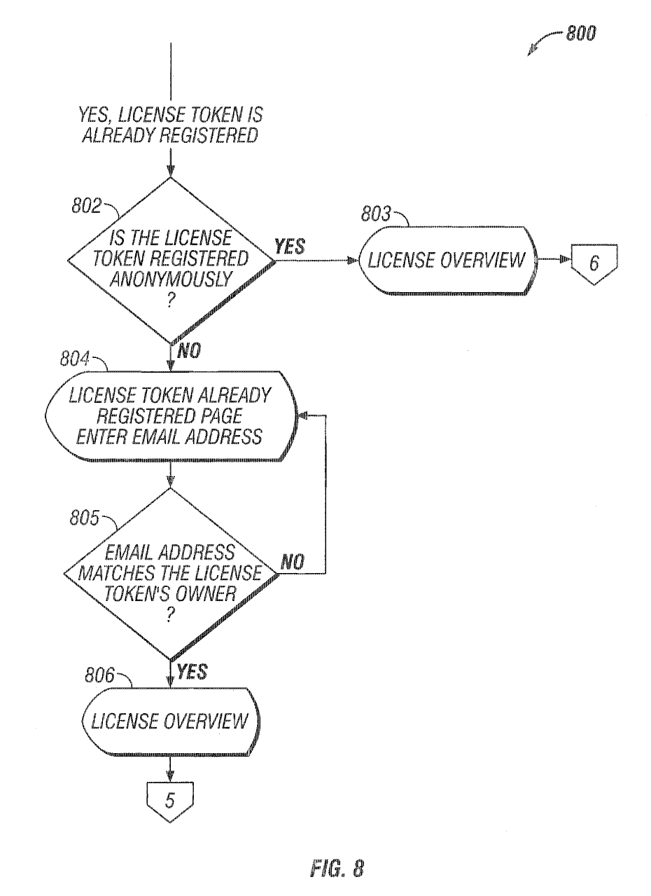

FIG. 5 diagrams the flow of a process 500 for registering a license token according to the invention. Having been provided a licensing token, either by the software producer or a partner, customers must register 501 their token in order to gain access to their entitled licenses and software products. The user first enters the license token 502. The system next attempts to validate 503 the token. The criteria for a valid token are that it exists, is active and not expired. In the case of returning customers 509, who may enter expired or inactive tokens, the token is updated and/or reactivated prior to being validated. The system then evaluates whether the token is already registered 505. If so, process flow proceeds as in FIG. 8. If not, the system determines if the license token allows profile registration 506. Next, the system determines if the token also allows anonymous registration 509. If not, then the system displays a form allowing profile registration only. The user then provides profile information 512 to register the token. The system then validates the information 514. If the validation generates an error, the customer may be required to re-enter some or all of his profile information. When the profile is successfully validated, the system creates 515 a member account and an order account based on the profile information and the license token information. Subsequently, the customer is permitted to view a license overview 516.

If, at 509, the system determines that the token also allows anonymous registration, then the system displays a form with both profile and anonymous registration. The customer then has the option of profile registration or anonymous registration.

If, at 506, the system determines that the license does not allow profile registration, it determines if the token allows anonymous registration. If not, an error is generated. If so, the user may register the license anonymously 513. The system creates a dummy account and member and an order based on the license token information 518. Subsequently, the customer is permitted to view a license overview 519.

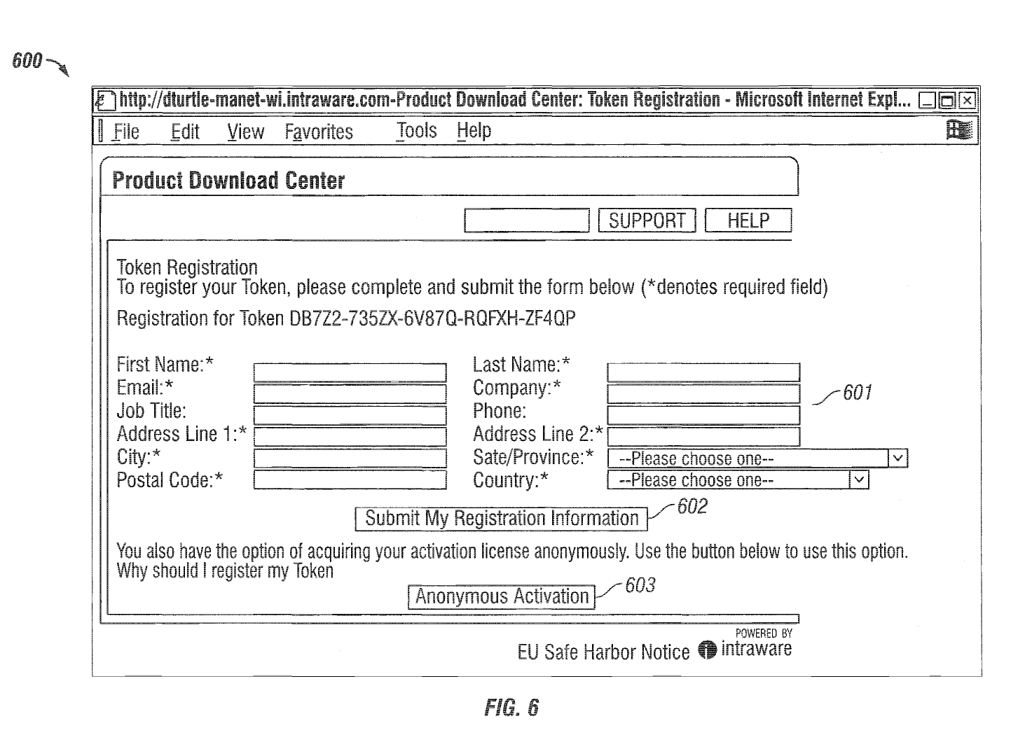

FIG. 6 shows a form 600 for token registration. The form 600 contains a plurality of fields for entry of customer information 601. As shown, the information requested includes:
First name;
Last name;
Email;
Company
Job title;
Phone;
Address line 1;
Address line 2;
City;
State;
Postal code; and
Country.

Some, or none, or all of the fields may be designated required fields. That is, if a field is required, it must be filled-in in order for the registration to be accepted. The nature of the information requested, the number of the fields and the arrangement of the form are a matter of design choice. Accordingly, other forms than the exemplary form of FIG. 6 are within the scope of the invention.

After completing the profile information, the customer submits the registration information by activating a “submit” element 602. As an alternative to the above procedure for filling out the registration form, the customer may simply elect to activate his or her license anonymously by activating an appropriate user interface element 603.

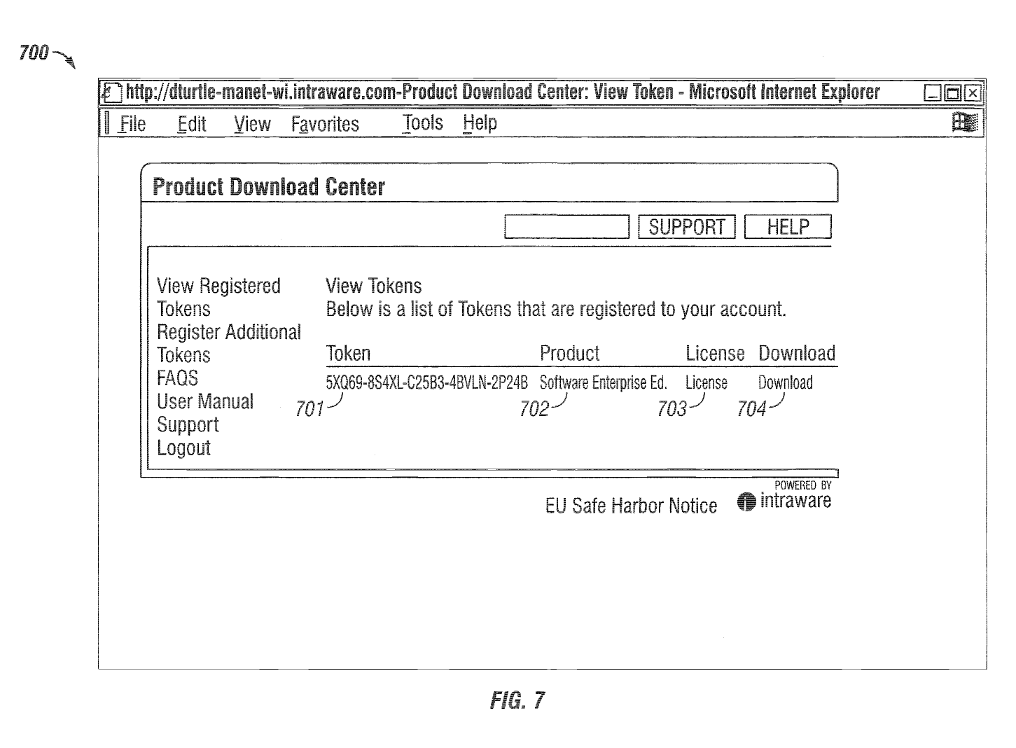

As above, after the system creates a member account and an order account the customer is permitted to view a license overview. FIG. 7 shows a form 700 for viewing the tokens registered to a customer account. The form lists the token 701, the entitled product 702 and indicates whether the token allows activation of a license or whether the customer can actually download the product 704.

FIG. 8 is a continuation of FIG. 5, wherein if the system determines at 507 that a licensing token is already registered, it determines 802 if the token is anonymously registered. If so, then the customer is allowed to view a license overview 803. If the token is not anonymously registered, the customer is prompted to enter authentication information, for example an email address 804. If the information does not match the information in the token owner's profile, the customer is prompted again. If the information provided matches that in the profile, the customer is allowed to view a license overview 806.

Distributing Entitled Licenses and/or Software to Customer Presenting One or More Tokens.

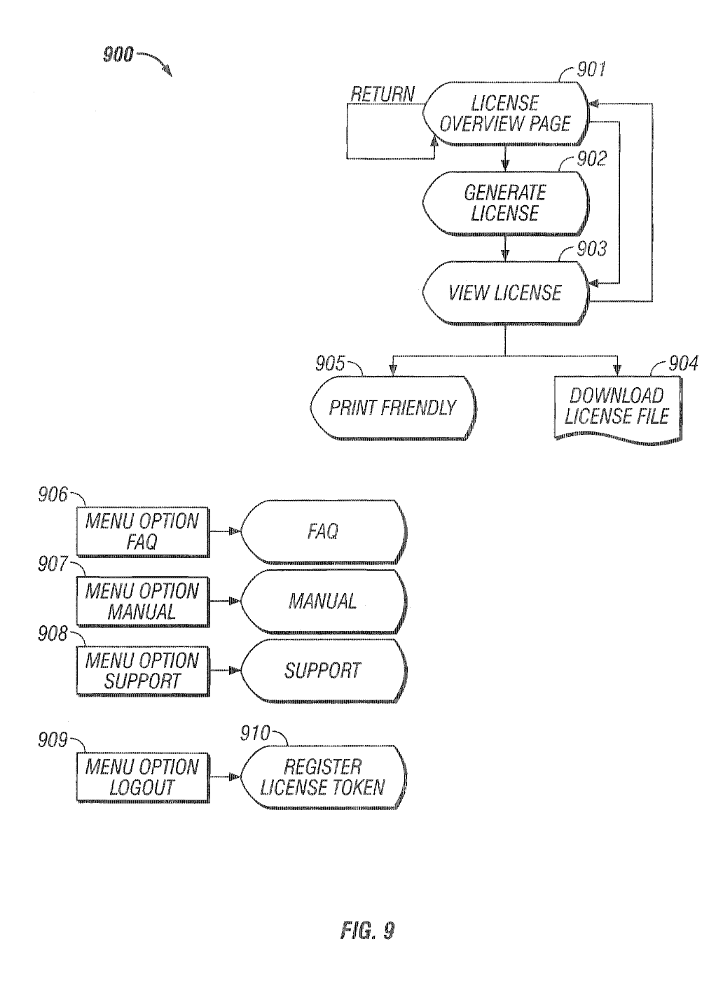

FIG. 9 illustrates process flow after a customer has anonymously registered a licensing token. The customer is allowed to view the license overview page 901. Subsequently, the customer generates a license 902 and views 903 the generated license. In another case, the license overview page allows the user to view a previously generated license. Subsequently, the customer may download the license file 904. Alternatively, or in addition, the system generates 905 a printer-friendly image of the license for the customer to print.

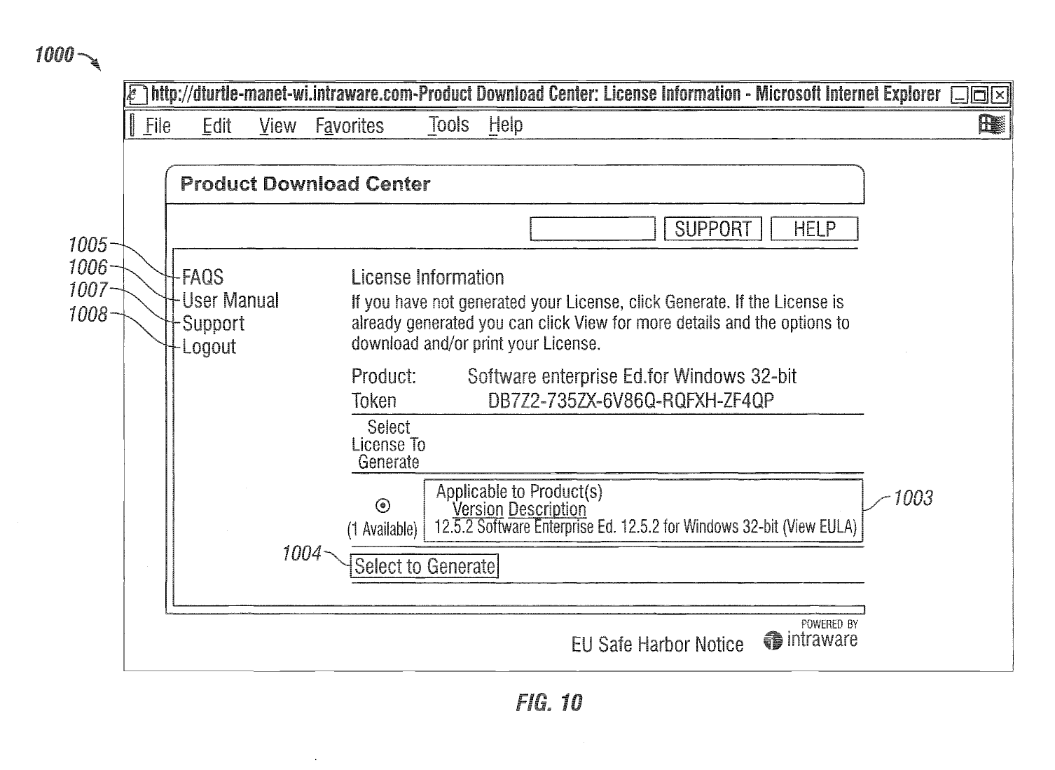

FIG. 10 illustrates a form for viewing a license overview for an anonymously registered customer. The form displays the entitled product 1001 and the token 1002 and the license 1003. The form 1000 also includes a user interface element 1004 whereby the customer can generate the indicated license by activating the user interface element 1004.

In addition to viewing the license overview page, the owner of an anonymously registered token has at his or her disposal a number of additional menu options such as, for example, FAQ 1005, User Manual 1006, Support 1007, and Logout 1008. Upon selecting logout 1008, the license owner may be given an opportunity to register the token to a customer profile.

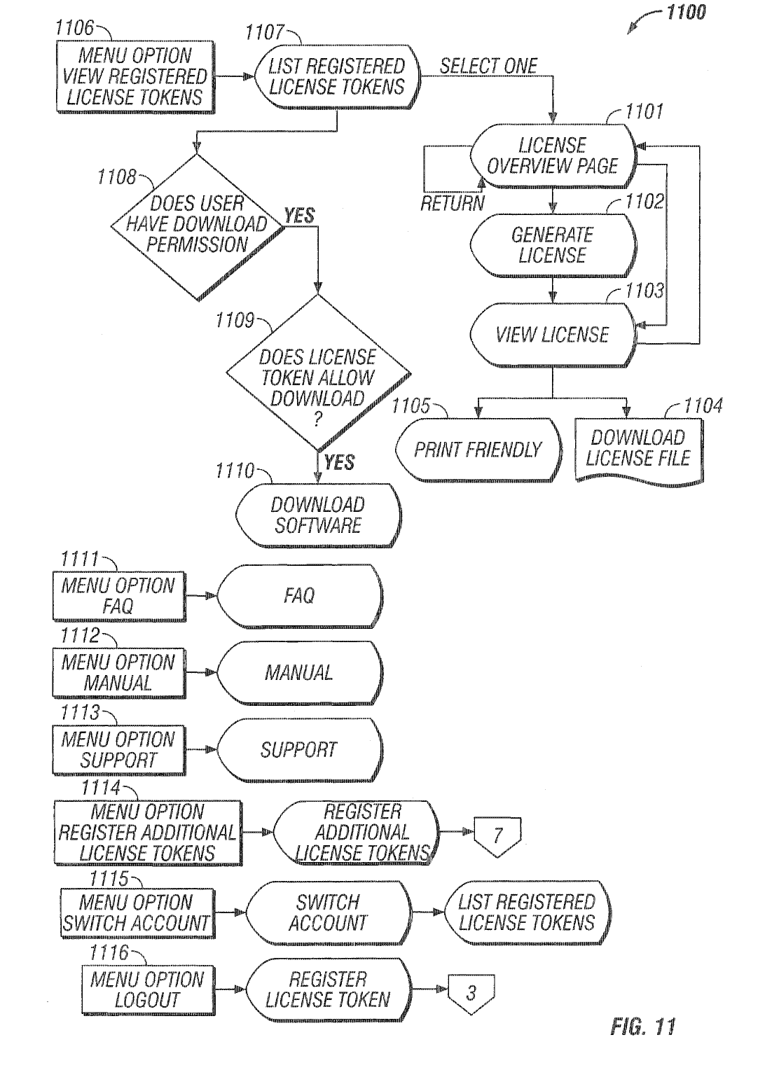

FIG. 11 illustrates process flow for a profile-registered customer. As with the anonymously registered customer, the customer is allowed to view the license overview page 1101. Subsequently, the customer generates a license 1102 and views 1103 the generated license. In another case, the license overview page allows the user to view a previously generated license. Subsequently, the customer may download the license file 1104. Alternatively, or in addition, the system generates 1105 a printable image of the license for the customer to print.

Additionally, the customer profile-registered customer is presented with an expanded set of menu options. Notably, the profile-registered customer is given a menu option for viewing all registered license tokens for the account 1106. Selection of this option generates a list 1107 of all registered tokens for this account, as shown in FIG. 7. The customer may select a token from the list, and view, generate, print and/or download the license 703 associated with the token. In addition, if the terms of the license permit it, the customer may download the software directly without generating or downloading the license 704. The system determines if the customer has download permission 1108. If so, then the system determines if the token allows software download 1109. If so, then the system allows download of the software 1110.

The UI (user interface) for the profile-registered customer also provides the same menu options 1201, 1202, and 1203 and 1204 as the UI for the anonymously registered customer. In addition, the profile-registered customer can register additional tokens 1205, view another account associated with the same customer and view the registered tokens for that account 1115, and logout 1116.

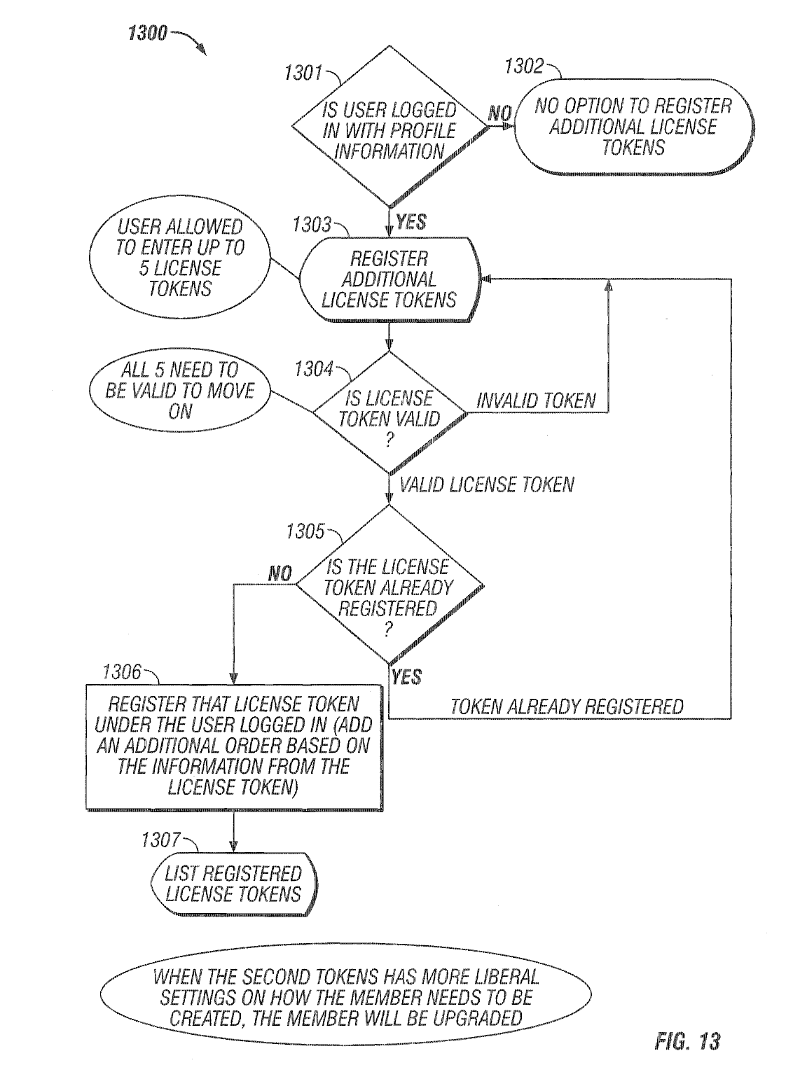

FIG. 13 illustrates process flow for a process for registering additional tokens. The system first determines if the customer has a profile and is authenticated 1301. If not, there is no option 1302 to register additional tokens. If yes, the customer is prompted to register additional tokens. In an exemplary embodiment, the customer may enter five additional license tokens. However, this number is merely a design choice and is not intended to limit the invention. The invention next determines if each of the entered tokens is valid 1304. If any of the tokens is invalid, the customer is prompted to enter additional tokens. In order to proceed to the next step, all tokens entered must be valid. The system next determines if the tokens are already registered 1305. If any of the tokens are already registered, the customer is prompted to enter additional tokens. If all of the tokens entered are not registered, the tokens are each registered to the customer owning the account 1306. Additionally, the system creates an additional order based on the information from each license token. Finally, the system provides a list of all registered tokens for this customer's account 1307. If a later added token allows more privileges, the customer is granted the upgraded privileges allowed by the token.

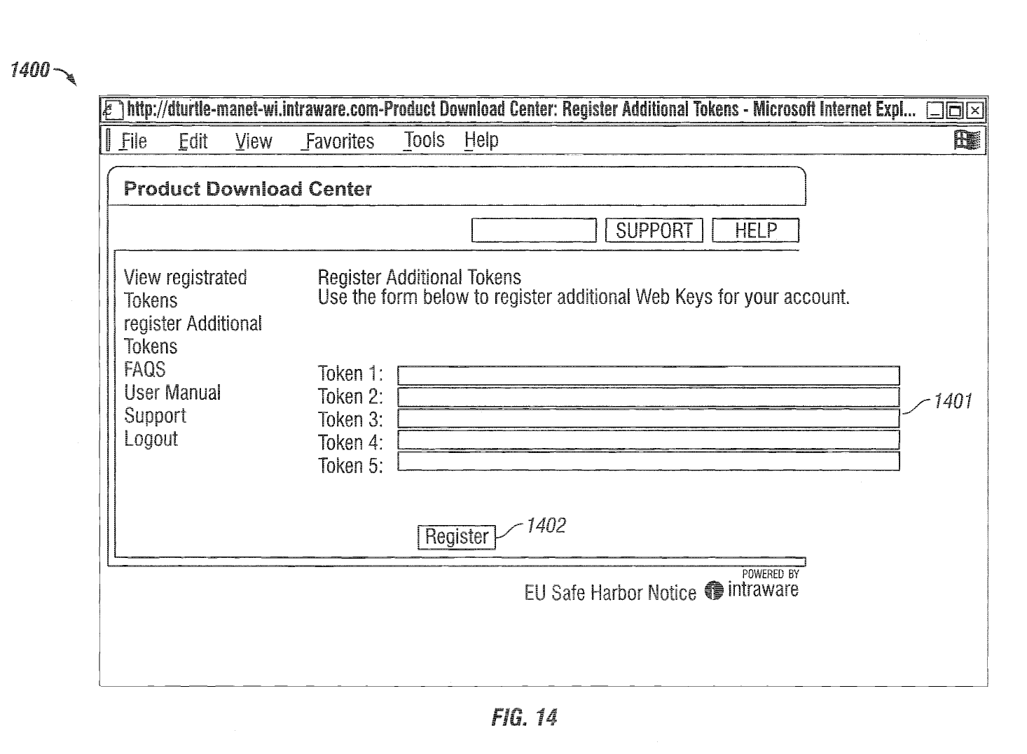

FIG. 14 shows a form for entering additional tokens. The form 1400 provides a plurality of user interface elements 1401 for entering additional tokens. After the tokens have been entered, the customer activates a user interface element 1402 to register the tokens. If the entered tokens are all properly validated as above, the tokens are registered to the customer's profile

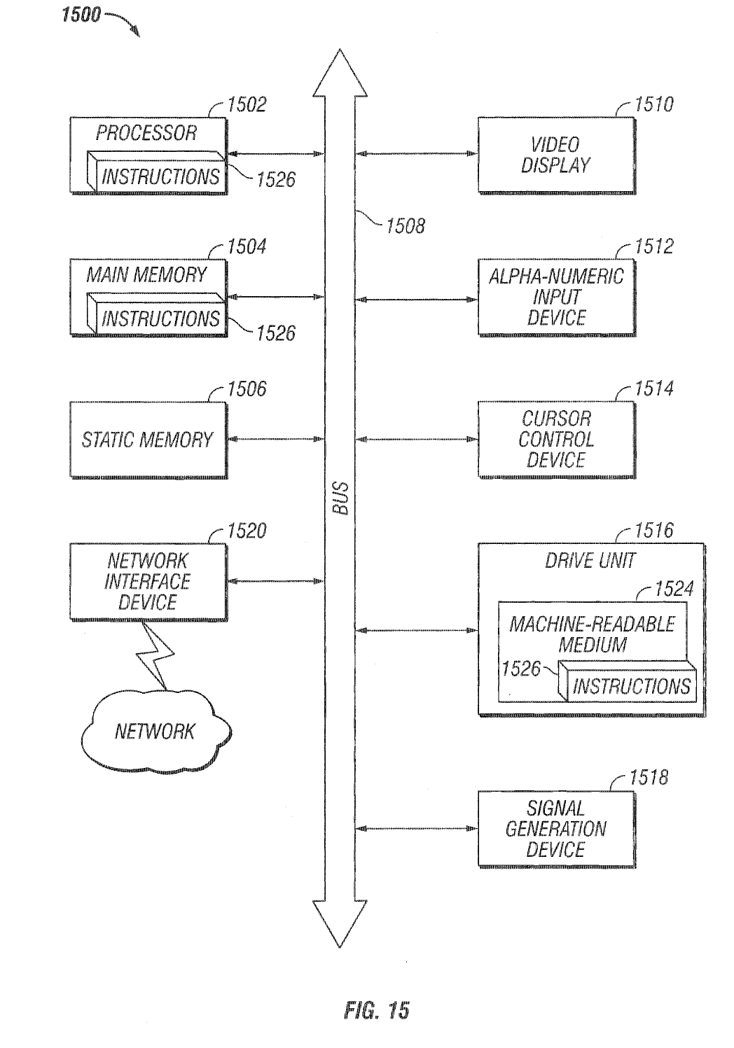

FIG. 15 shows a diagrammatic representation of a machine in the exemplary form of a computer system 1500 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1500 includes a processor 1502, a main memory 1504 and a static memory 1506, which communicate with each other via a bus 1508. The computer system 1500 may further include a video display unit 1510, e.g. a liquid crystal display (LCD) or a cathode ray tube (CRT). The computer system 1500 also includes an alphanumeric input device 1512, e.g, a keyboard, a cursor control device 1514, e.g. a mouse, a disk drive unit 1516, a signal generation device 1518, e.g. a speaker, and a network interface device 1520.

The disk drive unit 1516 includes a machine-readable medium 1524 on which is stored a set of instructions, i.e. software, 1526 embodying any one, or all, of the methodologies described above. The software 1526 is also shown to reside, completely or at least partially, within the main memory 1504 and/or within the processor 1502. The software 1526 may further be transmitted or received via the network interface device 1520.

In contrast to the system 1500 discussed above, a different embodiment of the invention uses logic circuitry instead of computer-executed instructions to implement processing entities such as the web servers 12, processing servers 16, etc. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof.

It will, however, be evident that various modifications and changes may be made thereto without departing from the broader spirit and scope of the invention as set forth in the appended claims. For example, while the invention has been described herein with respect to certain token generation schemes, embodiments of the invention are possible that support any unique token generation scheme. Furthermore, embodiments of the invention are possible that are compatible with alternate methods of distributing the tokens such as email, or downloading from web site. Additionally, paper tokens distributed through the mail or via print media such as newspapers and magazines are within the scope of the invention. While embodiments of the invention described herein above embody a scheme wherein submission of a token triggers creation of an entitlement, embodiments of the invention are possible wherein submission of a token by a user causes the submitter to be associated with a previously created entitlement such that submission of the token causes the entitlement to be activated.

The specification and drawings are, accordingly, to be regarded in an illustrative sense rather than a restrictive sense.

1. A computer implemented method of distributing a digital license and software product anonymously comprising the steps of:
receiving and validating at a server a license token submitted by an unknown customer;
creating a software license according to a license definition associated to said token; and
granting anonymous access at least to said license to said unknown customer.

2. The method of claim 1, further comprising the step of:
generating said license token and said license description.

3. The method of claim 2, wherein generating said license token comprises any of the steps of:
generating said license token by a software supplier;
generating said license token by a channel partner of said software supplier; and
generating said license token at an ESDM system distributing said software and said license on behalf of said supplier.

4. The method of claim 2, wherein generating said license description comprises the step of:
generating said license description by a supplier of said software product.

5. The method of claim 4, further comprising the step of:
transmitting said license description to said distributor by said supplier.

6. The method of claim 1, further comprising the step of:
requesting said customer to register before granting said anonymous access.

7. A computer-implemented method of acquiring a digital license and software product anonymously, comprising the steps of:
receiving a licensing token by a customer;
anonymously presenting said received licensing token for validation;
anonymously accessing at least said digital license based on said validation.

8. The method of claim 7, wherein said step of receiving a license token comprises any of the steps of:
downloading said license token;
receiving an e-mailed license token;
receiving a mailed license token;
receiving a license token as an attachment to a physical software package; and
receiving a license token in a publication.

9. The method of claim 7, wherein validation of said license token comprises the steps of;
determining that said license token exists;
determining that said license token is active; and
determining that said license token is current.

10. The method of claim 7, wherein said step of accessing said digital license comprises the step of;
viewing a license overview page; and any of the steps of;
printing said license; and
downloading said license.

11. The method of claim 7, further comprising the step of:
declining an invitation to register.

12. A computer implemented method of distributing a software license and software product via licensing token comprising the steps of:
receiving at a server a licensing token submitted by a customer;
determining if said licensing token has been previously submitted;
granting a bearer of a previously submitted token access at least to one or more software licenses associated to said license token;
prompting a bearer of a newly-submitted token either to register or to activate said license anonymously.

13. The method of claim 12, further comprising the step of:
validating said submitted licensing token.

14. The method of claim 13, wherein said step of validating said submitted licensing token comprises any of the steps of:
determining if said submitted token is valid;
determining if said submitted token is current; and
determining if said submitted token is active.

15. The method of claim 12, further comprising a step of:
if a previously submitted token was activated anonymously:
presenting a view of a license overview to said customer.

16. The method of claim 12, further comprising the step of:
if a previously submitted token is registered to a customer having a profile:
presenting a view of a license overview to said customer;
presenting a list of all entitlements associated to said customer profile;
permitting said registered customer to associate additional tokens to said customer profile; and
permitting said customer to download a software product without activating an associated license if an associated license token permits download.

17. A user interface for acquiring a software license and software product via licensing token comprising:
a form for submitting a license token;
a form for creating a customer profile, said form for creating a customer profile including a user interface element for activating a license anonymously without creating a customer profile;
a form for viewing tokens registered to a customer profile;
a form for viewing and generating a license anonymously; and
a form for viewing and activating licenses registered to a customer profile; and
a form for registering additional tokens to a customer profile.

18. The user interface of claim 17, wherein said form for viewing tokens registered to a customer profile comprises a listing of all tokens registered to a customer profile.

19. The user interface of claim 17, wherein said form for viewing and activating licenses registered to a customer profile comprises:
means for downloading a license; and
means for creating a printable version of a license.

20. A system for distributing a software license and software product via licensing token comprising:
a library for storing a plurality of digital objects, said objects being accessible by at least one customer who has either earlier subscribed to, or been entitled by an owner or developer of said digital objects to, ESDM services offered by an ESDM entity that operates said ESDM system;
a plurality of digital object manufacturers;
a plurality of channel partners, each channel partner having a predetermined business relationship with at least one said manufacturer;
wherein said manufacturers and said channel partners access said ESDM system via corresponding client machines residing at their respective sites;
a plurality of types of front-end web servers, which comprise any of servers that deliver web pages to multiple customers, servers that deliver images to be displayed within web pages, and servers that dynamically deliver content information to any of said customers, said manufacturers, and said channel partners, at least one of said web servers serving a user interface, said user interface comprising;
a form for submitting a license token;
a form for creating a customer profile, said form for creating a customer profile including a user interface element for activating a license anonymously without creating a customer profile;
a form for viewing tokens registered to a customer profile;
a form for viewing and generating a license anonymously; and
a form for viewing and activating licenses registered to a customer profile; and
a form for registering additional tokens to a customer profile;
at least one communication server for providing automated electronic communications to/from said customers, said manufacturers, and said channel partners;
at least one back-end server for facilitating delivery of digital objects from said manufacturers and said channel partners to their aggregated customer base which comprises said customers;
at least one processing server for authenticating customers based on presentation of licensing tokens and, upon successful authentication, making digital licenses accessible to customers presenting said tokens anonymously, and making said licenses and associated digital objects from said library available to said customers having customer profiles pursuant to licenses and entitlements registered to said profile;
wherein said ESDM system manages discovery and delivery of digital objects from said library to customers that are authorized to receive such objects by subscription, contract, payment, or other arrangement;
a database comprising a number of tables having entries, or records, that are linked by indices and keys, said database containing metadata relating to operation of said servers, said database comprising at least one token table which contains records for each licensing token furnished to said said ESDM system by a manufacturer or a channel partner, said token tables comprising licensing tokens and licensing token identifiers for all tokens, wherein said licensing tokens are either anonymously submitted and not associated to a particular user, or are registered to a particular user, said database also comprising on or more catalog item, product, license and order tables, which may be linked to the token tables and may be populated with account, product, license and/or order information related to a token said database further comprising one or more customer tables, wherein selected ones of said tokens are associated with registered customers on said system;
said customer tables comprising web server access codes, comprising a list of recognized users and password or other login information required to use a web site supported by said web servers, said customer tables also containing a mapping of which customers are authorized to access which of said stored digital objects contained in said library, according to their original purchase of products associated with such digital objects;
said database comprising a plurality of tables, which may also be linked to said customer table, including at least one manufacturer table that is configured to store data related to manufacturers that are allowed to access said ESDM system, and at least one channel partner table that is configured to store data related to channel partners that are allowed to access said ESDM system; and
said database further comprising one or more user-to-object tables that are configured to define which customers can access specific data objects or files within said library;
wherein if a customer restriction is placed on a data object, then said data object is only exposed to the respective customer; and
wherein if no user restrictions exist, then said data object is available to any customer entitled to receive the respective information.

21. The system of claim 20, wherein anonymous submission of a licensing token by a customer allows that customer to activate and access just that license associated to the anonymously submitted token.

22. The system of claim 20, wherein registering a licensing token to a customer profile allows said customer to activate and access any license associated to the customer account, and wherein said customer is further allowed to download software products without activating a license if a license definition for an associated token permits it, and wherein said customer is permitted to edit preferences and configuration of said user profile and wherein said customer is further permitted to register additional keys to said profile.
